(19) United States
(12) Patent Application Publication
(10) Pub. No.: US 2005/0138633 A1
(43) Pub. Date: Jun. 23, 2005

(54) Method and system for confirming the launch of interstitial content on an end user computer

(76) Inventors: Jonathan Barsade, Wynnewood, PA (US); Udi Latarre, New York, NY (US); Adam Zell, Sunnyvale, CA (US)

Correspondence Address: INNOVAR, LLC, P O BOX 250647, PLANO, TX, 75025, US

(21) Appl. No.: 10/997,781

(22) Filed: Nov. 24, 2004

Related U.S. Application Data
(60) Provisional application No. 60/524,870, filed on Nov. 26, 2003.

(51) Int. Cl. G06F 9/44

(52) U.S. Cl. 719/313; 719/315; 719/316

(57) ABSTRACT

A network advertising system and method includes a network server, a computer user, pop data packet, multiple web page files, and a display. The pop data packet includes user viewable data, launch command language, status command language, and failure command language. The user viewable data is displayed interstitially or non-interstitially on the monitor in a pop window of a browser program. The present system ensures that user viewable data intended for display in a pop window is actually displayed. The system determines whether or not a pop window was opened and whether or not the user viewable data was displayed in the pop window. Optionally, the system also determines whether or not the user viewable data was displayed for at least a minimum predefined period of time. If either of these conditions occurs, the failure command language directs display of the user viewable data by alternate means. Optionally, the failure command language directs the end user computer to download another pop data packet or user viewable data packet for display in a pop window.

### CROSS-REFERENCE TO EARLIER FILED APPLICATION

The present claims the benefit of priority of U.S. Provisional Application for Patent Ser. No. 60/524870 filed Nov. 26, 2003, the entire disclosure of which is hereby incorporated by reference.

### FIELD OF THE INVENTION

The present invention relates generally to a system and method of advertising on a network, and more specifically, to a system and method of ensuring or confirming that certain content is launched during a web browser session at an end user's computer, and, in the event of failure to launch said content, alternative content is downloaded and launched instead during the same web browser session.

### BACKGROUND OF THE INVENTION

Pop content (pop-up and pop-under) is web based content that is launched in a browser window that is separate and distinct from the main browsing window that had launched the pop-content. Pop content is oftentimes used to deliver on-line advertisements, but many other forms of content can be delivered to an end-user computer using the pop window method. For simplification purposes only, this disclosure shall focus upon the delivery of advertisements, but those knowledgeable in the art will recognize that the disclosure is equally applicable to the delivery of any forms of content using pop window. Pop advertisements are a form of web advertisement (like banner advertisements, interstitial pages, text advertisements, and buttons) that appears in a separate window, either as a screen that is placed behind the current window (also known as a pop-under ad), or a screen that overlays the current window in which the main browsing activities are occurring (pop-up ad). These advertisements convey certain information to the user, and may require the user to take some form of action (even if it is to simply close the window). The benefits are that the user can simply continue to browse the web in the main window without being interrupted, yet still engage an action with the advertisement if desired, at a later time.

However, the pop advertisements create another window in the user's screen, which the user did not request. Such an action can be considered intrusive and annoying. In fact, there is a strong resentment by web surfers towards pop ads, in particular towards pop-up ads. Marketers often do not realize the ill-will generated by pop-up advertisements because it is easier to click the “close” button than send an email to complain. What can often be seen is an above-average click-through rate; although, some of this can come from “false positives,” which are unintentional clicks when the pop-up gets in the way of the desired target.

Not all content of pop windows is advertising. A different embodiment of pop windows is for software usability and utility purposes. In many instances, for example, the designer of a web site or software developer defines a separate window, of specific size and screen location, to be launched. These separate windows are launched for different purposes, such as for displaying movie clips, or context sensitive information (help “balloons”), or requesting some form of input from the user, but are not limited to those. In many of these cases, the absence of the pop window will reduce the user's experience as some information will be missing. In other cases, internal scripting will cause errors if the pop-up is not present, impairing the usability of the web-site or software application, and even rendering web-applications dysfunctional.

As a result of the extended use of pop windows, and the respective user aggravation described above, there is a proliferation of software programs that their purpose is to block the launching of pop-up windows.

Different estimates and surveys show that 20%-40% of web-users have some sort of a pop-window killer. This number is growing steadily, as ISPs and major content providers block pop-up ad content (Yahoo, MSN, Netscape, Earthlink, to name a few.) The new Google™ Toolbar 2.0 has a built-in pop-up killer. When AOL launched version 8.0 in October, 2003, CEO Jonathan Miller said, “it's time to give pop-ups the knockout blow”. Microsoft recently integrated pop-up blocking features to Internet Explorer as part of its update for Windows XP. There are over 100 different applications (some free) that serve the purpose of “killing” pop-ups. See for example, U.S. Pat. No. 6,778,194 to Jones.

Even so, the demand for pop windows methods of information delivery, such as pop-ads by marketers, continues. On-line advertisers continue to seek new technologies for confirming, increasing and/or ensuring user interaction and exposure to advertising content on the Internet. Software applications and web content continue to require the use of a pop window for the delivery of application specific information, and the absence of the pop window is further rendering the application dysfinctional. There are multiple disclosures of systems and methods for monitoring and reporting of the launching and rendering of web based content, such as advertisements. See, for example, U.S. Pat. No. 6,553,417 to Gampper, U.S. Pat. No. 6,317,782 to Himmel. There are also multiple disclosures of systems and methods for monitoring and reporting of the downloading and launching of web based content, such as advertisements. See, for example, U.S. Pat. No. 6,314,451, and No. 6,516,338 to Landsman. However none of these disclosures discuss the ability to take real-time corrective action in the event of failure to properly render such content, such as the immediate downloading and rendering of alternative content using an alternative delivery method, to assure the successful rendering and displaying of data to the end user computer.

U.S. Pat. No. 6,553,417 to Gampper discloses an Internet data access acknowledgment applet and method of use thereof. The method ensures that usage information concerning a web site or advertisement is provided to an originator of data or advertising. An applet is embedded within accessible code, the applet is executed upon access of the accessible code, returning user related information, such as the IP address of the user, to the originator of the accessible code. The accessible code may be an advertisement. The system gathers additional information and waits until a triggering event occurs before returning the additional information and the identity of the user. The triggering event includes closing of data associated with the accessible code being viewed by the user or viewer movement to another space. The additional information comprises how long the space was viewed, the number of other links accessed, and the identification of other similar links accessed.

U.S. Pat. No. 6,351,745 to Itakura et al. discloses a communication system for distributing messages such as advertisements to an end user computer. The system includes a terminal connected to a communications network, a user database for storing the characteristics of each user, a message database for storing messages, and a transmittal condition database for storing the user characteristics of the class of suitable recipients for each message. A message searcher searches for messages from the transmittal condition database based on the characteristics read out from the user database. A reader reads the retrieved messages from the message database and a transmitter transmits the messages to the terminal. An adder increases the value of a parameter associated with each user when the transmitted message is displayed on the terminal. A detector detects whether the user is active, and a stop means prevents the value of the parameter from being increased when the user is inactive.

U.S. Pat. No. 6,317,782 to Himmel et al. discloses an apparatus and method for detecting the actual viewing of advertisements contained in Web pages or the like, recording the detected information, and transmitting the recorded information when necessary. The above noted features are accomplished through the use of a Java Applet in combination with JavaScripts (or other Dynamic HTML language) and cookies. If an advertisement is not rendered in a browser, the system does not provide for rendering of another advertisement.

U.S. Pat. No. 6,314,451, No. 6,516,338, No. 6,687,737, No. 6,785,659 and No. 6,466,967 to Landsman et al. disclose an ad controller for use in implementing user-transparent network-distributed advertising and for interstitially displaying an advertisement. The system employs a technique for implementing in a networked client-server environment, e.g., the Internet, network-distributed advertising in which advertisements are downloaded, from an advertising server to a browser executing at a client computer, in a manner transparent to a user situated at the browser, and subsequently displayed, by that browser on an interstitial basis, in response to a click-stream generated by the user to move from one web page to the next. Specifically, an HTML advertising tag is embedded into a referring web page. This tag contains two components. One component effectively downloads, from a distribution web server and to an extent necessary, and then persistently instantiates an agent at the client browser. The other component is a reference, in terms of a web address, of the advertising management system. The ad management system selects the given advertisement that is to be downloaded, rather than having that selection or its content being embedded in the web content page. The system can monitor the counts of click-throughs and reportedly provides proper accounting to an advertiser by accurately and validly ascertaining user impressions of fully rendered advertisements. An AdController applet specifies a successful presentation of a complete advertisement at a client browser. This system does not provide for the presentation of a second different advertisement if and when the first advertisement is not displayed correctly.

U.S. Pat. No. 6,128,651 to Cezar discloses an Internet advertising system with controlled and timed display of ad content obtained from a centralized system controller. A non-scrolling ad display is lodged in a website to cause browsers hitting the website to undertake centrally controlled and recorded ad display for guaranteed minimum timed intervals. The system enables precise controlled advertising to each web page viewing browser and accurate advertising budgeting and programming which can be monitored and upgraded to meet marketing needs. The components participating in the system include a website at a webserver for transmitting a page with code for installing a non-scrolling ad frame. Ad content for the non-scrolling ad frame each have individual timers for timing out commencing with display at the browser and an Internet address for fetching by the browser. A central controller with a firewall protected data base directs non-scrolling frame set up in the browser; generates, dispenses and interrogates for unique browser identifiers; maintains records associated with the unique browser identifiers indicating ads displayed and ads available for display; and, finally dispatches to inquiring browsers ad content addresses. The database provides an audit trail from which websites can be compensated for ad display and advertisers billed for the ad display. Finally, an inquiring browser has the non-scrolling frame set up on the browser, ad content displayed within the browser for a sufficient time interval to timeout the timer, report to the central controller of the display, and retrieval of the address of the next ad content for display.

U.S. Pat. No. 6,014,698 to Griffiths discloses a system using a first banner request that cannot be blocked from reaching a server for accurately counting the number of times a banner is displayed on network terminals, i.e. end user computers. A terminal initiates access or connection to a desired computer or web site to access a desired page. After the desired page is downloaded and served to the terminal from the computer or web site, the terminal initiates and sends an initial banner request signal to an information server. The information server returns a redirect signal to the terminal telling the terminal the location of the desired banner on the computer network, which may be the information server, the computer site, or some other information server, computer site, or location accessible via the computer network. The terminal then initiates a second banner request signal to the location of the desired banner and the banner is downloaded to the terminal for display on the terminal, unless the requested banner has previously been stored or cached in the terminal's memory or in the memory of a local or proxy server connected to the terminal, in which case the second banner request signal is not sent across the computer network and the banner is loaded directly from the terminal's memory or the proxy server. The system is capable of counting each time a banner is displayed on the terminal as a result of the redirected second banner request.

U.S. Pat. No. 6,009,409 to Adler et al. discloses a system and method for scheduling and controlling delivery of advertising in a communications network. The system includes: (1) a time allocation controller that allocates time available in a particular advertising region in a display device of a remote computer between at least two advertisements as a function of one of a desired user frequency, a desired time frequency, or a desired geometry, for each of the at least two advertisements and (2) data communication controller, coupled to the time allocation controller, that delivers the at least two advertisements to said remote computer for display in the advertising region according to the allocating of the time.

U.S. Pat. No. 6,006,197 to d'Eon et al. discloses a system and method for assessing the effectiveness of an Internet marketing campaign. It is a Web advertising measurement system that correlates the number of impressions of Web advertisements with post-impression transactional activity to measure the effectiveness of the advertisements. When a user clicks on a banner advertisement, an impression is established and the user's identification is recorded. Then, when the user undertakes post-impression transactional activity such as downloading software related to the advertisement, ordering products and services related to the advertisement, and so on, the transactional activity along with the user's identification is recorded. Based on the user identifications, the number of impressions associated with the advertisements are correlated to the post-impression transactional activity as a measure of effectiveness of each advertisement

U.S. Pat. No. 5,937,392 to Alberts discloses a banner advertising display system and method with frequency of advertisement control. An Internet advertising system has a database, a controller, and an ad server operating as part of a web server. The database has advertising campaign information, including identification information and frequency information for how often the ad is to be served. The ad server uses the campaign information from the database to control the relative ratios of serving ads, the distribution of ads throughout the day, and any triggering mechanisms for controlling what ads are served. The system can generate reports that can be used to provide to advertisers verification that their ads were actually displayed in the frequency and at the times expected, as well as the number of times the viewer clicked on the ad and the “click yield”.

U.S. Pat. No. 5,948,061 to Merriman et al. discloses a method of delivery, targeting and measuring advertising over networks. Statistics are compiled on individual users and networks and the use of the advertisements is tracked to permit targeting of the advertisements of individual users. In response to requests from affiliated sites, an advertising server transmits to people accessing the page of a site an appropriate one of the advertisement based upon profiling of users and networks. The system includes a report process that is used for generating online reports about the success rate of the advertisement and statistics on the users that are viewing and clicking through on various advertisements and also updating the counters in the database that store how often an advertisement has been displayed. The system can generate reports showing the number of viewings and click-throughs of various advertisements by a user.

U.S. Pat. No. 5,848,397 to Marsh et al. discloses a method and apparatus for scheduling the presentation of messages to computer users. An advertisement display scheduler resident on a user's computer receives advertisements from a server system over a network. Upon receipt, the advertisement display scheduler determines the priority of the advertisement and assigns it to one of a plurality of prioritized advertisement queues. Each queue is sorted according to predetermined scheduling criteria so that advertisements deemed “more important” are presented to a user first. The advertisement display scheduler logs statistical information relating to the presentation of advertisements for use in updating the scheduling criteria, and makes such statistical information available to the server system. The advertisement display scheduler can monitor the client system for extended periods of inactivity (i.e., the time between key strokes) and “times out” if there is no activity within a predetermined period of time (e.g., five minutes). This is a highly-desirable feature from the standpoint of advertisers, who understandably do not want to be billed for advertisements that are presented on an unattended video display monitor. Conversely, this feature provides advertisers with a relatively high degree of assurance that a user has actually viewed the images presented by the advertisement display scheduler.

None of the prior art systems discloses the invention as detailed herein. Accordingly, a need remains for an on-line system and method that overcomes the disadvantages of the known pop window systems. Such a system would provide a user with increased exposure to content, such as advertisement content, even if the initial method for delivering such content is through a pop-window.

### SUMMARY OF THE INVENTION

The system and method of the invention seeks to overcome the disadvantages inherent in the conventional pop advertising systems and methods used on the Internet.

It is the purpose of this invention to develop and disclose a system and method that will identify when a pop window is not launched upon the computer of the end user, or to identify if such a pop window was launched, but quickly and prematurely shutdown by software (running on the end user's computer) or by the user himself. In any of those cases, an alternative action will be taken upon such determination to cause the display of data to the end user. It is the further purpose of this invention to develop and disclose more specifically a system and method that will identify when, in all likelihood, a pop advertisement was not viewed by the end user either because the pop advertisement (pop under or pop-up) was not launched into the user's computer, or, in the alternative, was launched, but the user closed the window at a very quick pace that, in all probability, did not allow the user to view and absorb the advertisement being launched in the pop window, and, in which case, undertaking an alternative action to cause the display of the advertisement to the end user.

The claimed system and method monitors whether or not certain content was delivered to the end user via the pop window, and in the event of failure to deliver the content via the pop window, the claimed system and method will cause the delivery of content to the end user's browser using an alternative delivery method. The alternative delivery system can use different methods of delivery, such as DHTML, frames, and such other forms, protocols scripting languages and standards known in the art.

One proposed embodiment for the proposed invention is software that is placed in the main browser session evaluates whether or not the pop window is open. One embodiment of such code is JavaScript, and such other scripting languages commonly used in the industry. One method for evaluating whether or not said pop window is open is by sending a request-for-response to the pop window in pre-defined time intervals. The software may determine that the pop window is not available when said requests do not receive a return response. Another method is to embed a portion of the script in the pop window itself, enabling it to “communicate” with its parent window. Receipt of this communication, or the lack of it, can be represented in a script to the status of the pop window (open/opened and closed/never opened.)

Once such software determines that the pop-window is not open, it evaluates whether the pop window was open for a predefined minimum time period. If the pop window was open for a time period that equals or exceeds the predefined time period, the software will terminate. If the pop window was not open for a time period that equals or exceeds the predefined time period, the software will take a defined course of action. In one embodiment of the invention, a course of action could be (but is not limited to) the launching of an advertisement in an alternative method, such as an advertisement that is displayed in the same browser session as that of the main surfing activities (using such methods known in the art such as DHTML, frames, iframes), displaying of instructional (“help”) text in the case that the pop window is essential for the continued operation of the browser or functional software, and so on. This alternative course of action would ensure the party that is inserting the content into the pop window, such as an advertiser or software or website developer, that the user is exposed to said content, or at least is aware of its existence.

One aspect of the invention provides a method of determining the status of the launch and/or display of a pop window comprising predetermined pop data, and taking corrective action to address the failure to launch and/or display said pop window, the method comprising the steps of:

a) a pop data distribution server receiving a request to download a pop data unit to a user computer running a browser program;

b) downloading a first unit of pop data to the user computer, the pop data unit comprising: user viewable data; and software containing at least:
i) launch command language instructing the browser program to launch a pop window in a display operably connected to the user computer and to display the user viewable data in the display;
ii) status command language to determine whether or not the pop window is launched or open, and the user viewable data is or was displayed in the display; and
iii) failure command language for responding to a failure to display the user viewable data in the pop window and causing the display of data using an alternative display method;

c) in the user computer, executing the launch command language;

d) in the user computer, executing the status command language thereby determining whether or not the pop window was launched and the user viewable data was displayed, optionally for at least a predetermined period of time; and,

e) if it is determined that the pop window was not launched and/or the user viewable data was not displayed at least for the predetermined period of time, executing the failure command language and causing the launching and display of a data unit using an alternative display method.

Another aspect of the invention provides a system for distributing pop data over a network, the system comprising:
a) plural end user computers connected to the network, one or more of the end user computers having a display operably connected thereto and being equipped with a browser program; and
b) at least one pop data distribution network server connected to the network and comprising accessible storage comprising plural pop data units, wherein a pop data unit comprises: user viewable data, and a pop data recipient computer connected to the network and comprising accessible storage comprising:
   1) launch command language instructing the browser program to launch a pop window in a display operably connected to the pop data recipient computer and to display the user viewable data in the display;
   2) status command language to determine whether or not the pop window is launched and the user viewable data has been displayed in the display for at least the predefined period of time; and
   3) failure command language for responding to a failure to display the user viewable data in the pop window and causing the display of data using an alternative display method.

Specific embodiments of the invention include those wherein: 1) step d) further includes the steps of: d′) determining whether or not the browser program failed to launch a pop window; 2) step d) further includes the step of d′) determining whether or not the user viewable data was displayed after the pop window was launched; 3) step d) further includes the step of d′″) determining whether or not the user viewable data was displayed for at least a predetermined period of time after the pop window was launched; 4) the launch command language and the status command language are JavaScript, ActiveX, VBscript, RainMan, HTML Scripting, ActionScript and such other languages known in the art or a combination thereof; 5) the status command language comprises software which periodically queries the status of the pop window and monitors for corresponding responses; 6) upon confirmation that the pop window is not open, determining whether or not the pop window had been open for at least a predefined period of time, and if so, taking no further action, and if not, causing viewable data to be displayed to the user using alternate means such as by displaying in the main content window, or displaying instructional information in the main content window or yet another pop window; 7) the method further comprises the step of: f) the pop data distribution server downloading a second unit of data to the user computer for display in a pop window or the main content window, the second unit being the same as or different than the first unit of pop data.

### BRIEF DESCRIPTION OF THE DRAWINGS

The following drawings are part of the present specification and are included to further demonstrate certain aspects of the invention. The invention may be better understood by reference to one or more of these drawings in combination with the detailed description of the specific embodiments presented herein.

FIG. 1 depicts an exemplary network comprising plural end user computers and pop data distribution network servers.

FIG. 2 depicts an exemplary general logic flow chart of the steps as it occurs on an end user computer during the method of the invention when incorporated into a pop window data system.

FIG. 3 depicts an exemplary logic flow chart that describe the system and method of the invention as it occurs on a pop data distribution server in communication with an end user computer processing a pop data packet of the invention.

FIGS. 4a-4d depict alternate embodiments of a network suitable for the invention.

### DETAILED DESCRIPTION OF THE INVENTION

As used herein, an end user computer is a computer in communication with or connected to a network either directly or indirectly such that the computer is capable of receiving from and transmitting to the pop data distribution server data packets. An end user computer has a display operably connected thereto for displaying user viewable data included within a pop data unit. The end user computer is also equipped with a browser program capable of creating a pop window in the display or opening a secondary browser instance, either as a separate thread or as a child process of the main window session.

As used herein, a pop data distribution server is a computer that contains one or more data units (or data packets) that is typically rendered into an independent browser window, is in communication with or is connected to a network either directly or indirectly such that the server is capable of receiving from and transmitting to the end user computer data packets.

As used herein, a pop data unit is a packet of information comprising at least: 1) user viewable data that is typically rendered into an independent browser window. Command language instructing a browser program to launch a pop window in a display operably connected to an end user computer and to display the user viewable data in the display may be included in the pop data unit or in an independent data unit. Status command language to determine whether or not the pop window is launched and the user viewable data is displayed in the display may be included in the pop data unit or in an independent data unit.

As used herein, user viewable data includes any data typically transmitted via a network for the purpose of being viewed or heard by a user of an end user computer connected to the network.

As used herein, launch command language includes plural executable commands in a program, subprogram, routine, subroutine, script, applet, cookie or combination thereof, wherein the commands the browser program in an end user computer to launch a pop window and display user viewable data for at least a predefined period of time.

As used herein, status command language includes plural executable commands in a program, subprogram, routine, subroutine, script, applet, cookie or combination thereof, wherein the commands the end user computer to determine whether or not the pop window is launched and the user viewable data is or was displayed in the display for at least the predefined period of time.

A browser program is exemplified by Microsoft Internet Explorer, Netscape, America Online, Mozzila, Firefox, Opera and other such programs that display content received by an end user computer via a network.

A network, as used herein, is a hardwire network, a wireless network, virtual network or a combination thereof. It can be the Internet, an intranet, a local network or a cluster of sub-networks

As used herein, failure command language includes plural executable commands in a program, subprogram, routine, subroutine, script, applet, cookie, or combination thereof, wherein the language commands the end user computer to determine whether or not a pop data unit is actively rendered in the display operably connected for displaying user viewable data.

As used herein, response command language includes plural executable commands in a program, subprogram, routine, subroutine, script, applet, cookie or combination thereof, wherein the response command language enabling the pop window to communicate with the main content window by sending status response data to the main content window. The response data includes, for example, an indication as to whether or not the pop window is “open”, was “opened and closed” or was “not opened”.

As used herein, status response data includes data which indicates whether or not the pop window was launched, whether or not the pop window was launched and remained open. The data optionally includes an indication as to whether or not the pop window was launched, whether or not the pop window was launched and remained open for at least a predefined period of time, whether or not the user viewable data was rendered viewable in the pop window, whether or not the user viewable data was rendered viewable for at least a predetermined period of time, and/or in which window of the browser the user viewable data was rendered viewable.

Since the present invention predominantly employs a pop window format of presentation is a browser program, its content is clearly distinguishable from the content of a target requested web page, i.e., the main content page.

The pop window can be viewed interstitially, i.e. it can be viewed between requested main content pages (user requested web pages) such as during the time period in which a first web page is being removed from a browser window and a requested second web page is being downloaded onto a computer and ready for viewing in the browser window, or it can be viewed simultaneously with the main content window/page. Many systems and methods are known for presenting pop data, and the launching and rendering of pop windows is a known command integrated into common browsers, such as Explorer, and is a technique commonly employed by software programmers.

In one embodiment, the pop data packet, comprising user viewable data, is downloaded a first time from a pop data distribution network server onto and stored in the memory of the computer of a web user (web surfer). Downloading of the pop data packet can be initiated by various means, such as a request submitted by a web content page for the display of advertisement content. The user viewable data can be available for viewing immediately after its first download onto the web user's computer or after a delay period.

If the pop data packet is adapted for interstitial viewing, the system can take advantage of the time period during which the web surfer is an interested and captive audience, i.e., the period that occurs during downloading of a requested web page. Alternatively, the pop window can be open persistently or it may be part of a fixed area in the field of the display. The pop window can be launched either on top of the main browser window, so that from the viewpoint of the user, the pop window is covering the main browser session, either in part or in its entirely. In another embodiment, the pop window can be launched behind the main browser window, so that from the viewpoint of the user, the pop window is not viewable until the user minimizes, resizes, or shuts down, the main browser session.

A pop data file according to the invention can comprise one file or a cluster of files or other forms of data streams used in computer network communications. For example, a web page generally comprises a cluster of graphics and text files as well as embedded scripts. As used herein, the term “pop data” refers to a single file or a cluster of files, or other forms of data streams used in computer network communications, that together comprise the content of the user viewable data. The cluster of files can be referred to as an html file, which file generally comprises a cluster of other file types that are downloaded sequentially or concurrently onto a user's computer. Exemplary file types include html, text file, graphics file, executable script, JavaScript file, active-X file, flash file, multimedia file, video file, music file, audio file, CGI script, macro-media director file, Real file, QuickTime file, mpeg file, tiff file, gif file, pdf file, MIDI file, plug-in file and others known to those of ordinary skill in the art.

When the user viewable data stream creates an audible advertisement, the data stream is “displayed” by rendering it audible to a user through a speaker or other sound-generating component associated with the user computer. When the user viewable data stream creates a viewable advertisement, the data stream is “displayed” by rendering it viewable to a user through a monitor or other visual signal-generating component associated with the user computer. Accordingly, a display component of a user computer is either a monitor, speaker, headphone, projector or other such conventional components typically operably engaged with a user computer.

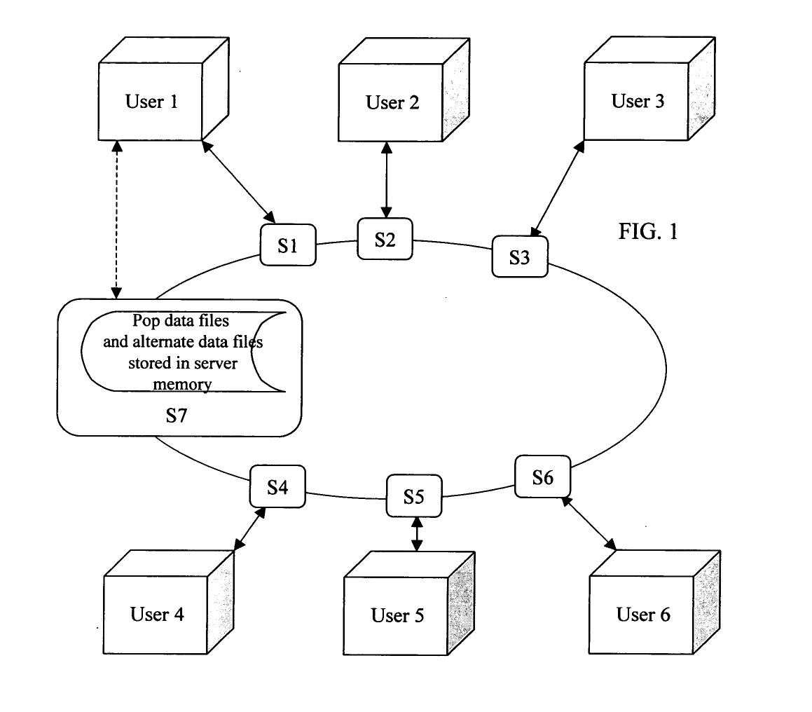

FIG. 1 depicts an exemplary network comprising plural end user computers (User 1-User 6) and pop data distribution network servers (S1-S7). The server (S7) includes a memory (information storage medium) comprising stored pop data files and alternate data files. The network can be an external network, such as the Internet, or an internal network, such as an Intranet. The users access the network through normal channels such as a T1 line, telephone modem, computer modem, cable modem, DSL modem, fiber optic cable, wireless modem, and such other access means that are commonly known in the industry of computer networks' access technologies. For example, User 1 accesses the Internet by using a computer modem connected to a telephone to connect to the Internet server S1, which belongs to an Internet Service Provider (ISP). User 2 accesses the Internet by connecting to the server (S2) via a cable (TV) modem. User 3 accesses the Internet by connecting to the server (S3) with a T1 line, and so on. Alternately, a user can access the server (S7) containing the pop data files directly, as shown by the dashed arrow, using any of the above-mentioned methods. Where the system is an Intranet, the server (S7) can be the central or a peripheral server.

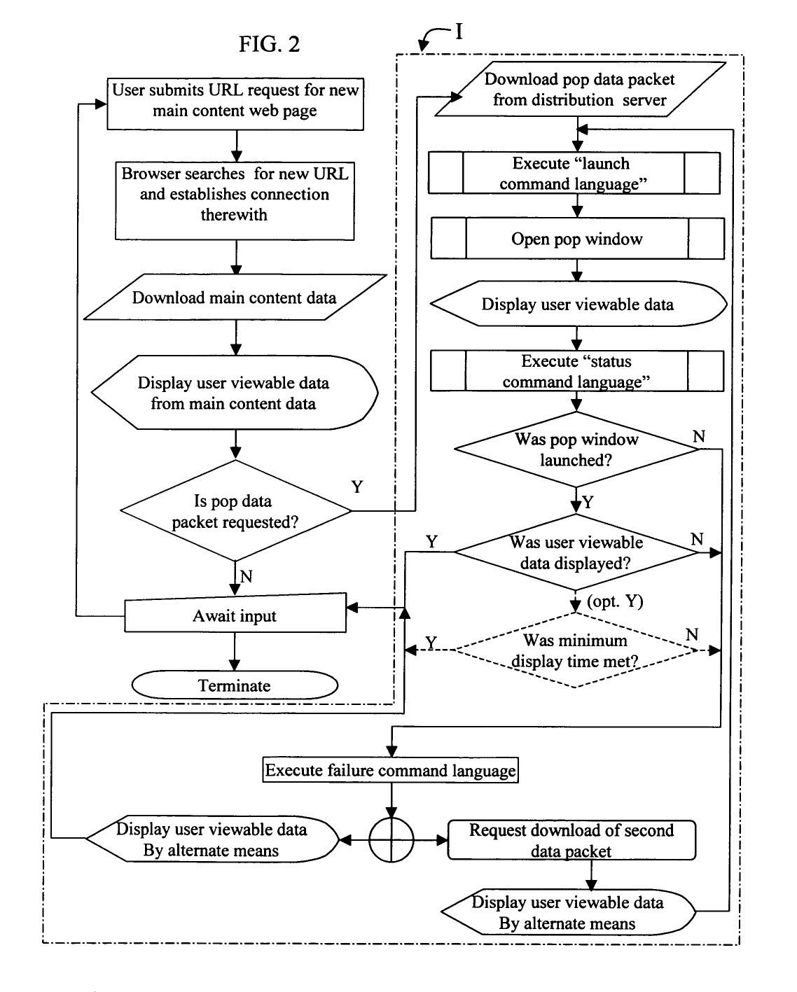

FIG. 2 depicts an exemplary embodiment of a logic flowchart wherein the method of the invention is incorporated into an advertising system. The steps enclosed within the dotted-hashed line box (I) are those that are included within the method of the invention. In such systems, the main content data packet is requested by and downloaded to a user computer. The main content data packet can include an embedded request for a pop data packet or it can include the content of a pop data packet within it. In either case, a main browser window is opened and the user viewable data of the main content data is rendered in that window. The pop data packet is downloaded and the launch command language is executed. A pop window is opened, or an attempt to open the pop window is made. If the pop window opens, the user viewable data of the pop data packet is rendered, or an attempt to render the user viewable data in the pop window is made. Status command language is executed. The status command language determines whether or not the pop window was launched and whether or not the user viewable data was displayed in the pop window for at least a predefined period of time. If the pop window was launched and the user viewable data was displayed in the pop window, the status command language is terminated and the process is returned to awaiting user or system input. If the pop window did not launch and/or the user viewable data was not displayed in the pop window for at least the predefined period of time, failure command language is executed. The failure command language responds to a failure to display the user viewable data in the pop window by causing the display of user viewable data using an alternative display method, as described herein. In one optional embodiment, the failure command language includes further language requesting the download of a second packet of data to the user computer for display using an alternate means, such as in the main content window using iframes or DHTML type technologies, the second packet of data being the same as or different than the first packet of pop data. In another optional embodiment the method would use the pop window data packet for display using an alternate means, such as in the main content window using iframes or DHTML type technologies.

This exemplary method includes the optional step of determining whether or not the user viewable data was displayed in the pop window for at least a predefined minimum amount of time. If not, the failure command language is executed. If so, the status command language process is terminated.

The method of the invention occurs in the foreground or the background, so the user viewable data within the main content data is displayed in the main content page regardless of operation of the present method.

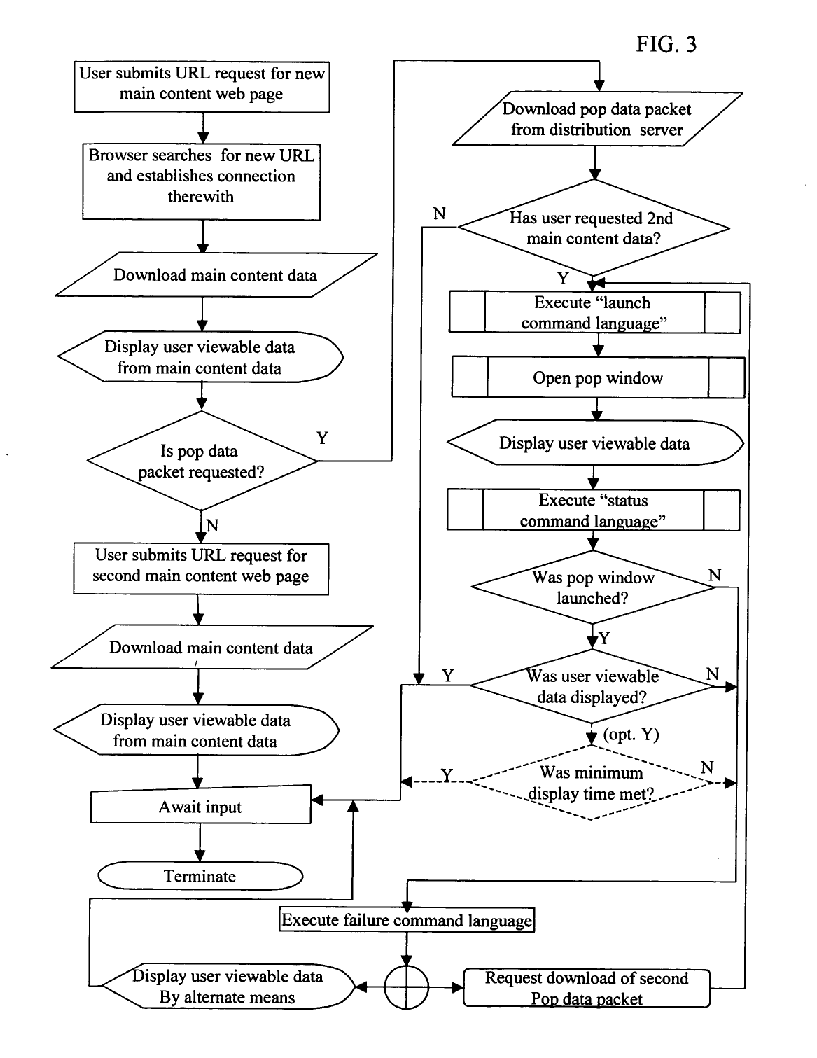

FIG. 3 depicts a general schematic of the steps involved in the interstitial embodiment system and method of the invention as they can occur during a browser session on the Internet or other computing network system, for example. The process is very similar to that of FIG. 2; however, in this case, the execution of the launch command language depends upon whether or not the user has requested a second main content page. If so, the pop data launch command language is executed. If not, the program awaits user input prior to proceeding.

In an exemplary interstitial embodiment, after a user has connected to the computer network and has a browser window open, he submits a request for a specific web page using any of the conventional procedures, such as by clicking on a link, or entering the URL (Uniform Resource Locator) address of the web on the address bar of the browser window. After receiving the request, the browser program searches the network for the requested web page and establishes a connection with it. As the requested web page is being downloaded onto the user computer from a server, a BA program according to Barsade et al. (copending U.S. patent application Ser. No. 10/113,114 filed Mar. 29, 2002) opens a pop data packet previously downloaded onto the user computer. The user viewable data therein is served up to a pop window of the browser. While the pop window is open, the web user may have several options available to him. For example, he may optionally freeze (pause) the pop window, request another web page via the pop window or close the pop window. Other options may also be available. These options are elected by entering keyboard commands, using the graphic user interface, utilizing voice commands, retinal scanning systems, clicking on one or more active links placed within the pop window in a manner similar to the placement and activation of hyperlinks in standard network web pages or utilizing such other methods commonly used for communicating between the user and the computer. When the pop window is frozen, the user can proceed to the requested web page window, while keeping the pop window open. The user can request another web page via the pop window by clicking with a mouse on an active link in the pop window. By doing so, the browser program begins to search the network for the just requested page. The newly requested page can be downloaded into the same window as the pop or into another pop window. Once a predetermined percentage or amount of the first requested page has been downloaded onto the user computer, or after a predetermined time period has lapsed, the pop window closes and the window with the first requested page is served up. While the first requested page is being viewed by the user or being downloaded onto the user's computer, the original pop data file is optionally replaced on the user's computer with another one. In other words, the pop data file replacement occurs in the background preferably without disrupting the user's viewing of the first requested page.

The above-described system is adapted to include the features of the present invention that permit determination of the viewing status of the ad, the user viewable data in the pop data packet. According to the invention, the pop data packet comprises user viewable data. The invention also contains software that includes (1) Launch command language instructing the browser program to launch a pop window in a display operably connected to the user computer and to display the user viewable data in the display for at least a predefined period of time; 2) status command language to determine whether or not the pop window is launched and the user viewable data has been displayed in the display for at least the predefined period of time and to provide corresponding display status data to the pop data distribution server; and 3) failure command language for directing the user viewable data to be displayed by another means in the browser program. The failure command language optionally further comprises request command language for requesting another data packet from the network server so that the requested additional data packet can be processed as described herein. The launch command language, status command language and failure command language may be contained together in a single or multiple software components, or in any combination thereof, and may be contained in the pop data packet, or in an alternative data packet, integrated with a content data packet or independent thereof.

One or more active links can be included in a pop window according to the invention. Suitable active links include all types of links known in the field of Internet programming and web pages. Upon each occurrence, an active link can independently comprise an ACTIVE-X™ control, FLASH™ control, flash animation, image, macro-media director file, real, QuickTime, MPEG, MIDI, executable files, a combination thereof or such other files that are commonly known in the industry of software programming. An active link is activated, by a viewer of the user viewable data in the pop window, by employing either a mouse (graphic user interface device), commands and/or the keyboard. Activation of an active link will cause the opening of a different browser session, which will open with the web page requested by such active link. The main browser program will then return to the main session that includes the just requested web page.

The server subroutine that is part of the present method is available in a number of different embodiments. Although referred to herein as a subroutine, the server subroutine can also be a macro such as CGI script for the server and such other subroutines commonly known in the industry of Internet software programming. According to one server subroutine, a pop data distribution network server receives a request for a pop data packet. The server retrieves the pop data packet file from its memory and downloads it to the end user computer. Upon completion of the server subroutine, the server awaits receipt of a request for another pop data packet.

Given the potentially diverse content of the pop data packet files, they can be categorized into and/or indexed according to classes, subclasses, genera, groups and/or subgroups. Alternatively, they can be identified according to unique identifiers, such as unique URL's addresses. A pop data file can, therefore, be requested according to a class, subclass, genus, group, and/or subgroup to which the file belongs. Likewise, the file can be requested according to its unique identifier. In other words, a specific pop data file or an unspecified pop data file, which is a member of a specific group, subgroup, class, subclass, and/or genus of pop data files can be requested.

The identity of a specified pop data packet can be determined according to a number of methods. For example, a web page that a user is currently viewing might include embedded command language specifying the identity of the packet to be requested. Accordingly, while the web page is being viewed, a subroutine of the pop data packet obtains the identity of the specified pop data packet from the web page and sends its identity to the network server by way of the server subroutine described above. The command language embedded in the web page may be JavaScript, applet or such other command languages commonly known in the industry of Internet web page programming.

Alternatively, the identity of the specified pop data packet can be determined by information stored on the user's computer in the form of a cookie, which information can be called upon to determine the identity of the specified packet. The identity of the specified packet can also be determined by the origination and address of the requested web page or by information stored on a server or other centralized computing system in the form of data that can be called upon to determine the identity of the specified packet.

The content, especially the user viewable content, of a specified pop data packet may or may not be related to the content of the web page that a user was viewing or has requested.

The pop window can include a header identifying its content so as to reduce consumer confusion between the pop window and the requested web page.

Click-on capabilities (e.g. hyperlinks) may be added to the pop window. When a hyperlink is activated, a new browser session can be opened (so as not to disrupt the main surfing session), and the user will be linked as per the click-on request.

If a user computer or a network server fails to execute any of the command language included in the browser program, pop data packet, server subroutine or other such software, the respective program can be terminated by a user. Alternatively, the program is terminated by the computer by including in such programs conventional termination sequences and command language. For example, the pop data packet can include a termination sequence to occur after a predetermined time period, or the failure to load of the requested web page.

The system and method of the invention is generally intended for passing along predetermined information to an end user; however, it is especially useful in marketing any good or service. In one embodiment, the pop data packet is provided to licensees or subscribers of an advertisement service provider (AdSP), which network servers include the pop window user viewable data. Typically, the code for requesting the downloading of a pop data packet is included in a web page in the form of hyperlinks, or programming language, such as JavaScript or applets, which are incorporated into the web page, or such other script or software language commonly known in the network communications programming industry. Such script includes programming language that submits requests to the server to submit user viewable data files. Such script includes additional programming language that enable the features otherwise described herein, including instructions to launch the pop data packet file upon submitting the request for the requested second web page. By integrating the pop data packet activation code into the web page, licensees will have ultimate control as to when and how the packet is launched. The program would be activated when surfing web pages published by licensees who sign onto the advertising service, and accept the AdSP's licensing terms. Alternatively, the program is activated when surfing (going) from a licensee web site to a non-licensee web site because it will have been activated by the code incorporated into the licensee's page.

In general, the system and method of the invention may be used to conduct e-commerce under any of a number of scenarios. Under one interstitial scenario, an advertisement service provider (AdSP) has one or more servers containing user viewable data files or pop data packets. An e-commerce company (EC) having a business website subscribes to the ad-serving business of the AdSP. The website of the EC includes one or more web pages and one or more of those web pages includes a pop data program (otherwise called a pop data packet) and respective activation code embedded in the page. The pop data program on a web page includes a request for a specific user viewable data file from the server of the AdSP. A first-time customer of the EC connects to the web page having the embedded pop data program. While a viewer is viewing the EC's we page, the pop data program obtains a user viewable data file from the server of the AdSP and downloads it onto the user's computer. When the user requests another web page the pop data program is activated and the user viewable data file is served up to a browser window, while the user is waiting for the content of the requested web page to download. After download of the requested page is complete, the pop window is superceded by the requested web page, and the pop data program continues along its intended logic path.

Any network, in particular Internet, browser program can be used. Suitable browser programs include MICROSOFT™ Internet Explorer browser, NETSCAPE™ browser, AMERICA ONLINE™ browser, YAHOO™ browser, PRODIGY™ browser and other such programs.

As used herein, a network data stream server (NWDS-SR) is a server that comprises one or more network data streams. An information packet data stream server (IPDS-SR) is a server that comprises one or more information packet data streams, such as the pop data packet. A connectivity server (CON-SR) is a server that provides connectivity of an end computer (user computer) to a network of computer(s) and server(s). A network reporting system server (NWRS-SR) is a server that provides some of the above-described network reporting system functions. A network according to the invention can independently comprise one or more of each of the above-described servers. Connectivity between the components of the network can be established by hardwire and/or wireless systems. One or more of any server can be included within an end computer. Moreover, a single computer server can simultaneously function as one or more different servers as described herein. For example a single computer/server can act as a NWRS-SR, CON-SR, IPDS-SR and/or NWDS-SR. Alternatively, one server can provide two functions and another server optionally provide one or more other functions. Likewise, one server can provide three functions and another server optionally provide one or more other functions. Separation of the various components of the system into separate individual components is unnecessary.

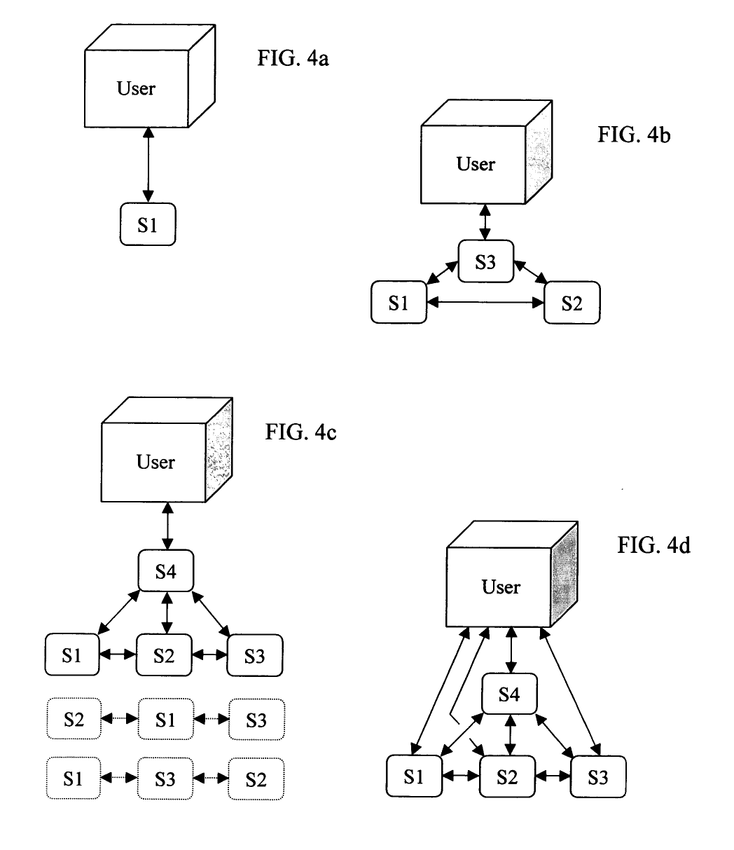

FIGS. 4a-4d depict various embodiments of networks that can be used with the system and method of the invention. The arrows indicate exemplary connections between the components of the network; however, any type of connectivity arrangement known in the art of computer networks can be used. In FIG. 4a, the user computer is connected to a single server that functions as the NWDS-SR, IPDS-SR, CON-SR, and optionally the NWRS-SR. In FIG. 4b, the user computer is connected to a CON-SR (S3), which is connected to two other servers (S1 and S3). The server (S1) functions as the NWDS-SR, and the server (S2) functions as the IPDS-SR. Either server (S1, S2 or S3) can optionally also function as the NWRS-SR. The server (S1) is optionally also connected to the server (S2). In FIG. 4c, the user computer is connected to a CON-SR (S4), which is connected to three other servers (S1, S2 and S3). The server (S1) functions as the NWDS-SR, the server (S2) functions as the IPDS-SR and the server (S3) functions as the NWRS-SR. The server (S2) is optionally also connected to the server (S1) and the server (S3). Alternatively, the server (S3) is optionally also connected to the server (S1) and the server (S2) (see dashed lines). Alternatively, the server (S1) is optionally also connected to the server (S2) and the server (S3) (see dashed lines). In FIG. 4d, the user computer is connected to a CON-SR (S4), which is connected to three other servers (S1, S2 and S3). However, the user computer is also directly connected to each of the other servers (S1, S2 and S3). The server (S1) functions as the NWDS-SR, the server (S2) functions as the IPDS-SR and the server (S3) functions as the NWRS-SR.

A network comprising an IPDS confirmation delivery system can comprise a first server comprising plural IPDSs, a second server comprising a network reporting system and at least one end computer to which an IPDS is delivered and for which confirmation of delivery is provided. Alternatively, the network comprises a first server comprising plural IPDSs and a network reporting system, and at least one end computer to which an IPDS is delivered and for which confirmation of delivery is provided. The network can comprise a connectivity server by way of which the end computer connects to the network. The connectivity server can also connect to either one or both of the above-described first and second servers.

As used herein, the term downloading generally refers to the process of reading a data stream from a network server into a browser window or into the memory of the computer. The term loading generally refers to the process of reading a data stream from the memory of the computer into a browser window.

As used herein in reference to a data stream (packet), the term “unload” refers to the process of removing the data stream from a window or frame of a multi-frame window. Alternatively, the term unload refers to the process of making a data stream not visible to a user such as by placing the data stream in a different window.

As used herein, a URL event is any event, prompted by the user or a software routine, that causes a second web page to be requested. Exemplary events include entering a URL address in the address bar of the browser program, clicking on an activated link in a web page, or clicking on a ‘Favorites’ web page, activating browser based code such as the “Back” or “Refresh” buttons.

As used herein, an activation code is a software routine, function or group of functions that initiates (starts) another program, routine, function or group of functions.

An “information packet data stream” is defined as a combination of data packets streamed to an end-user via a communication network, such as the Internet, that present upon the end-user computing machine an advertisement as described herein, when combined together by applying standard communication protocols, such as TCP/IP protocol, and software programs, such as Internet browser software applications.

It should be noted that as used herein, a network browser session is taken to mean a live connection from an end-user computing device to a communication network, such as a live connection between an end-user computer and Internet server, for the transfer and receipt of information data stream conducted utilizing a software browser program which translates information data streams in different formats into information that can be perceived by an end-user utilizing a computing device. A browser session can comprise one or more windows and, unless otherwise specified, each of the windows is managed independent of the other. A window of a network browser session is taken to mean the ability to split an information data stream display device permitting the display of multiple events simultaneously.

A pop-up and pop-under window need not necessarily include all the command options typically found in a browser window. As used herein, a pop-up window refers to a browser window that assumes a primary hierarchical position in a multi-window browser environment by being placed on top of or in front of what was the primary browser window, so that pop-up is the primary window that is viewable by the end-user. A pop-under window refers to a browser window that assumes a secondary hierarchical position in a multi-window browser environment by being placed below or behind a primary browser window. A primary window, in a multi-window environment, refers to a browser window which content is intended to be the primary focus of a user's attention as compared to other windows of the multi-window environment. Likewise, a primary flame, in a multi-frame window environment, refers to a browser window frame which content is intended to be the primary focus of a user's attention as compared to other frames of the same window.

The memory in which the pop data packet and its files is stored includes both volatile and non-volatile memory. The files can be stored in the random access memory (RAM), a memory cache, floppy disc, magnetic tape, magnetic storage devices, optical storage devices, DVD, CD, hard drive, ZIP™ DISC and such other memory systems that are commonly used in conjunction with network access and communication systems. The pop data packet in a user computer is preferably stored in a directory typically determined by the specific browser as a file or cluster of files. The pop data packet is a cluster of data streams that are formatted in a manner that are commonly used in network communication systems.

It should be noted that as used herein, a network browser session is taken to be synonymous with the viewing window of a network browser. The session (window) generally includes tool bars and icons typically used in browser programs.

The above is a detailed description of particular embodiments of the invention. It is recognized that departures from the disclosed embodiments may be made within the scope of the invention and that obvious modifications will occur to a person skilled in the art. Those of skill in the art should, in light of the present disclosure, appreciate that many changes can be made in the specific embodiments which are disclosed herein and still obtain a like or similar result without departing from the spirit and scope of the invention. All of the embodiments disclosed and claimed herein can be made and executed without undue experimentation in light of the present disclosure.

1) A method of determining the status of the launch and/or display of a pop window comprising predetermined pop data, and taking corrective action to address the failure to launch and/or display said pop window, the method comprising the steps of:
a) a pop data distribution server receiving a request to download a pop data unit to a user computer running a browser program;
b) downloading a first unit of pop data to the user computer, the pop data unit comprising:
user viewable data; and software containing at least:
i) launch command language instructing the browser program to launch a pop window in a display operably connected to the user computer and to display the user viewable data in the display; and
ii) status command language to determine whether or not the pop window is launched or open, and the user viewable data is or was displayed in the display, thereby determining whether or not the pop window was launched and the user viewable data was displayed, optionally for at least a predetermined period of time; and
iii) failure command language for responding to a failure to display the user viewable data in the pop window and causing the launching of a data unit using an alternative method and display of its user viewable data using an alternative display method;
c) in the user computer, executing the launch command language;
d) in the user computer, executing the status command language thereby determining whether or not the pop window was launched and the user viewable data was displayed, optionally for at least a predetermined period of time; and
e) if it is determined that the pop window was not launched and/or the user viewable data was not displayed at least for the predetermined period of time, executing the failure command language.

2) The method of claim 1 further comprising the step of:
f) if is determined that the pop window was launched and the user viewable data was displayed at least for the predetermined period of time, terminating this method.

3) The method of claim 1, wherein in step iii) the alternative display method comprises the use of DHTML, frames, or iframes.

4) The method of claim 1, wherein in step iii) the alternative display method comprises: a) the displaying the user viewable data in the same browser session as that of the main content window, displaying of instructional text in the case that the pop window is essential for the continued operation of the browser.

5) The method of claim 1, wherein the pop data unit is embedded within a main content data packet.

6) The method of claim 1, wherein determination of whether or not a pop window opened is conducted by sending a request-for-response to the pop window in pre-defined time intervals.

7) The method of claim 1, wherein step d) further comprises the step of: d′) determining whether or not the browser program failed to launch a pop window.

8) The method of claim 7, wherein step d) further comprises the step of d″) determining whether or not the user viewable data was displayed after the pop window was launched.

9) The method of claim 8, wherein step d) further comprises the step of d′″) determining whether or not the user viewable data was displayed for at least a predetermined period of time after the pop window was launched.

10) The method of claim 1, wherein the launch command language and the status command language include JavaScript, ActiveX, VBscript, RainMan, HTML Scripting, ActionScript or a combination thereof.

11) The method of claim 1, wherein the status command language comprises software which periodically queries the status of the pop window and monitors for corresponding responses.

12) The method of claim 1 further comprising the step of: wherein upon confirmation that the pop window is not open, determining whether or not the pop window had been open for at least a predefined period of time, and if so, taking no further action, and if not, causing viewable data to be displayed to the user using alternate means such as by displaying in the main content window, or displaying instructional information in the main content window or yet another pop window.

13) The method of claim 1, further comprising the step of: g) the pop data distribution server downloading a second unit of data to the user computer for display in a pop window or the main content window, the second unit being the same as or different than the first unit of pop data.

14) The method of claim 1, wherein the pop data unit comprises plural file types independently selected from the group consisting of html, text file, graphics file, executable script, JavaScript file, active-X file, flash file, multimedia file, video file, music file, audio file, CGI script, macro-media director file, Real file, QuickTime file, mpeg file, tiff file, gif file, pdf file, MIDI file, and plug-in file.

15) The method of claim 1, wherein the software further comprises request command language for requesting another data packet from the network server.

16) The method of claim 1, wherein two or more of the launch command language, status command language and/or failure command language are contained together in a single software program.

17) The method of claim 1, wherein two or more of the launch command language, status command language and/or failure command language are contained together in separate software programs.

18) The method of claim 1, wherein two or more of the launch command language, status command language and/or failure command language are contained in the pop data packet, or integrated within a main content data packet.

19) The method of claim 1, wherein the pop window comprises one or more active links.

20) The method of claim 19, wherein upon each occurrence the one or more active links independently comprise ACTIVE-X™ control, FLASH™ control, flash animation, image, macro-media director file, real, QuickTime, MPEG, MIDI, executable file, or a combination thereof.

21) The method of claim 1, wherein the browser program is selected from the group consisting of MICROSOFT™ Internet Explorer browser, NETSCAPE™ browser, AMERICA ONLINE™ browser, YAHOO™ browser, and PRODIGY™ browser.

22) A system for distributing pop data over a network, the system comprising:
a) plural end user computers connected to the network, one or more of the end user computers having a display operably connected thereto and being equipped with a browser program; and
b) at least one pop data distribution network server connected to the network and comprising accessible storage comprising plural pop data units, wherein a pop data unit comprises:
user viewable data, and a pop data recipient computer connected to the network and comprising accessible storage comprising:
i) launch command language instructing the browser program to launch a pop window in a display operably connected to the pop data recipient computer and to display the user viewable data in the display;
ii) status command language to determine whether or not the pop window is launched and the user viewable data has been displayed in the display for at least the predefined period of time; and
iii) failure command language for responding to a failure to display the user viewable data in the pop window and causing the display of data using an alternative display method.
